(19) United States
(12) Patent Application Publication
(10) Pub. No.: US 2015/0338708 A1
(43) Pub. Date: Nov. 26, 2015

(54) WIDE-VIEWING-ANGLE LIQUID CRYSTAL DISPLAY AND DISPLAY METHOD THEREOF

(71) Applicant: TRULY SEMICONDUCTORS LTD., Shanwei City, Guangdong (CH)

(72) Inventors: Lin Li, Shanwei City, Guangdong (CN); Junwen Hu, Shanwei City, Guangdong (CN); Shengbao Hong, Shanwei City, Guangdong (CN); Zepeng Zhang, Shanwei City, Guangdong (CN); Jiqiang He, Shanwei City, Guangdong (CN)

(73) Assignee: Truly Semiconductors Ltd., Shanwei City, Guangdong (CN)

(21) Appl. No.: 14/758,144

(22) PCT Filed: Feb. 1, 2013
(86) PCT No.: PCT/CN2013/071249

§ 371 Date: Jun. 26, 2015

(30) Foreign Application Priority Data
Dec. 31, 2012 (CN) 201210594508.X

(51) Int. Cl. G02F 1/1343

(52) U.S. Cl. CPC G02F 1/134363; G02F 1/13439

(57) ABSTRACT

Disclosed are a wide-viewing-angle liquid crystal display and a display method thereof, so as to improve the color cast problem generated during displaying by the wide-viewing-angle liquid crystal display. ITO slots of two or more directions are provided on a public electrode corresponding to a pixel electrode in a hollowed-out mode, so that liquid crystal molecules can be displayed in a multi-domain mode and are compensated from different viewing angles, and the fluctuation of liquid crystal molecules for the light refraction under an oblique angle is reduced, thereby improving the displaying effect of the wide-viewing-angle liquid crystal display.

### CROSS-REFERENCE TO RELATED APPLICATION

This application claims priority to Chinese patent application No. 201210594508.X, entitled “WIDE-VIEWING-ANGLE LIQUID CRYSTAL DISPLAY AND DISPLAY METHOD THEREOF” and filed with the State Intellectual Property Office of People's Republic of China on Dec. 31, 2012, which is incorporated herein by reference in its entirety.

### FIELD

The present disclosure relates to the technical field of liquid crystal display, and in particular to a wide-viewing-angle liquid crystal display and a wide-viewing-angle display method.

### BACKGROUND

At present, thin film field effect transistors (TFT) are increasingly widely used in people's life, such as in a mobile phone display screen, a GPS display screen, a computer display screen and an MP3 player display screen. With TFT technology, each liquid crystal pixel point on a wide-viewing-angle liquid crystal display is driven by a thin film transistor integrated behind the pixel point, hence information on a screen can be displayed with high speed, high brightness and a high contrast ratio.

In an existing TFT wide-viewing-angle liquid crystal display, a common electrode corresponding to each pixel electrode is hollowed out and there is no ITO at the hollowed-out location to form ITO slots arranged alternately. As shown in FIG. 1, the ITO slots are arranged in parallel, so that an in-plane electric field formed by the common electrode and the pixel electrode has a uniform direction. Therefore, liquid crystal molecules are driven in a single-domain mode, that is, the orientations of liquid crystal molecules in a single pixel are the same. In the single-domain mode, after the liquid crystal molecules are arranged and oriented, a color cast appears when the TFT wide-viewing-angle liquid crystal display is viewed at different angles, since the liquid crystal molecules refract light rays coming from different directions differently.

### SUMMARY

To address the above defect, a wide-viewing-angle liquid crystal display and a wide-viewing-angle display method are provided according to embodiments of the present disclosure, to alleviate a color cast during displaying of the wide-viewing-angle liquid crystal display.

According to an aspect of the embodiments of the present disclosure, a wide-viewing-angle liquid crystal display is provided, which includes a first substrate, liquid crystal molecules, common electrodes, pixel electrodes, a protection layer, a second substrate, Gate lines and Source lines; where ITO slots in two or more directions are formed alternately, in a hollowed-out mode, on a common electrode corresponding to each pixel electrode.

Preferably, a shape of the pixel may be diamond.

According to a second aspect of the embodiments of the present disclosure, a wide-viewing-angle display method is provided, which includes:

forming alternately, in a hollowed-out mode, ITO slots in two or more directions on a common electrode corresponding to each pixel electrode.

It can be seen from the above technical solutions that, embodiments of the present disclosure have advantages as follows.

In the embodiments of the present disclosure, ITO slots in two or more directions are formed alternately, in a hollowed-out mode, on a common electrode corresponding to a pixel electrode, which is different from a conventional single comb-shaped ITO slot arrangement, such that electric fields in multiple directions are formed by the common electrodes and the pixel electrodes, to drive liquid crystal molecules to display in a multi-domain mode. Various orientations of the liquid crystal molecules improve light transmittances of the liquid crystal molecules at different angles, hence alleviating the color cast of the wide-viewing-angle liquid crystal display effectively.

### BRIEF DESCRIPTION OF THE DRAWINGS

For clarity of the technical solutions according to the embodiments of the present disclosure, the drawings for the embodiments will be described briefly as follows. Apparently, the drawings in the following description merely illustrate a few embodiments of the present disclosure. For those skilled in the art, other drawings may be obtained according to these drawings without any creative work.

FIG. 1 is an arrangement diagram of ITO on a common electrode corresponding to a pixel electrode according to the conventional technology;

FIG. 2 is an arrangement diagram of ITO on a common electrode corresponding to a pixel electrode according to an embodiment of the present disclosure;

FIG. 3 is another arrangement diagram of ITO on a common electrode corresponding to a pixel electrode according to an embodiment of the present disclosure;

FIG. 4 is another arrangement diagram of ITO on a common electrode corresponding to a pixel electrode according to an embodiment of the present disclosure; and

FIG. 5 is yet another arrangement diagram of ITO on a common electrode corresponding to a pixel electrode according to an embodiment of the present disclosure.

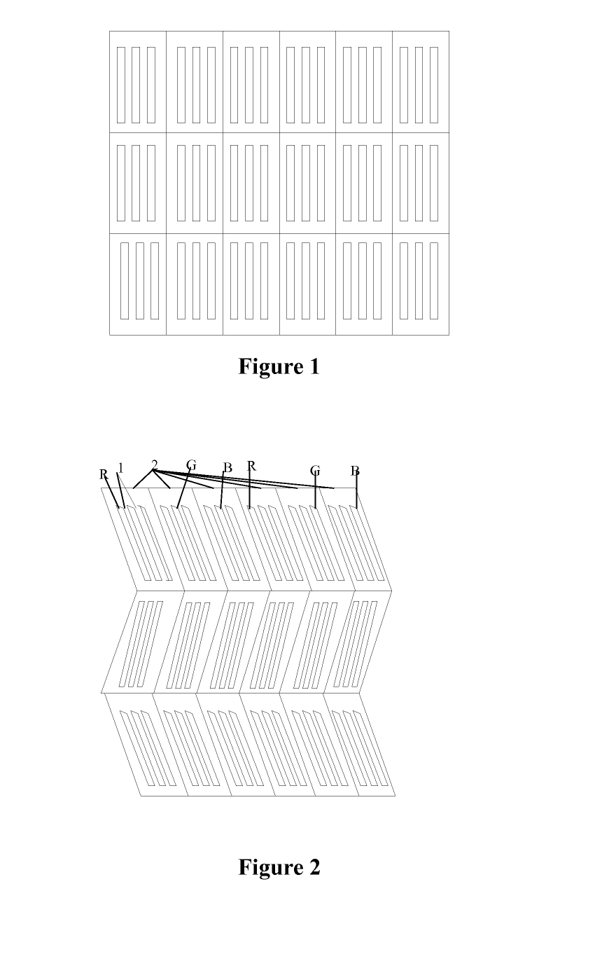

### DETAILED DESCRIPTION OF THE EMBODIMENTS

The technical solutions according to the embodiments of the present disclosure will be described clearly and completely as follows in conjunction with the drawings of the embodiments of the present disclosure. Apparently, the described embodiments are merely a few rather than all of the embodiments according to the present disclosure. Any other embodiments obtained by those skilled in the art based on the embodiments of the present disclosure and without any creative work fall in the scope of the present disclosure.

A wide-viewing-angle liquid crystal display and a wide-viewing-angle display method are provided according to embodiments of the present disclosure, to alleviate color cast during displaying of the wide-viewing-angle liquid crystal display. The display and display method may be applied to a mobile phone, a laptop display screen, a television display screen, a GPS display screen and the like. It should be understood by those skilled in the art that, the display and display method may also be applied to other devices using a wide-viewing-angle liquid crystal display, which is not limited herein.

A wide-viewing-angle liquid crystal display is provided according to an embodiment of the present disclosure, which includes a first substrate, liquid crystal molecules, common electrodes, pixel electrodes, a protection layer, a second substrate, Gate lines and Source lines; where ITO slots in two or more directions are alternately formed, in a hollowed-out mode, on a common electrode corresponding to each pixel electrode.

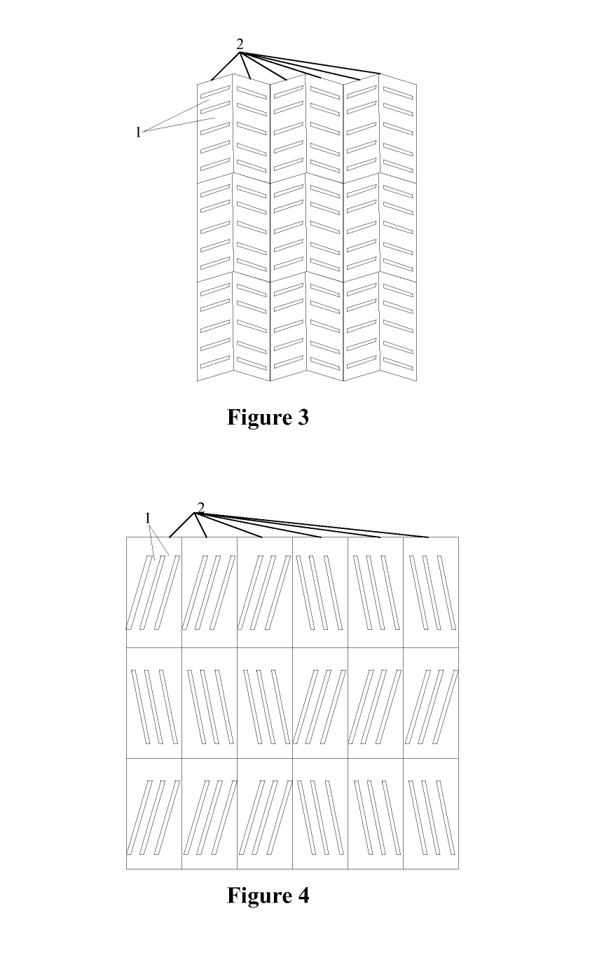

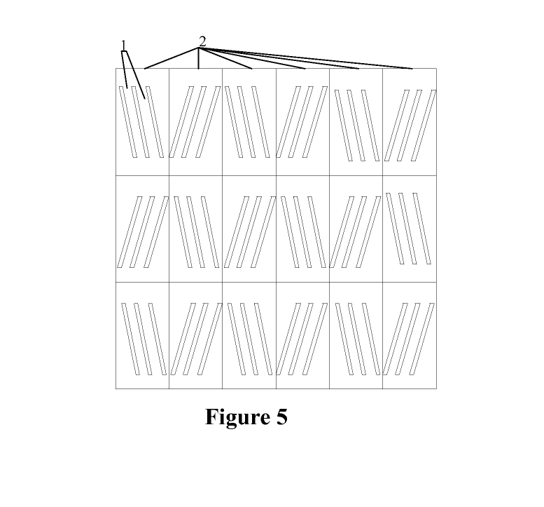

For color displaying, each pixel electrode includes a red sub pixel electrode, a green sub pixel electrode and a blue sub pixel electrode; and for black-and-white displaying, each pixel electrode includes a monochromatic sub pixel electrode. ITO slots in at least two or more directions are formed alternately, in a hollowed-out mode, on a common electrode corresponding to each sub pixel electrode, and the pixel electrode may be changed into a diamond shape. The Gate lines and Source lines are correspondingly arranged in a Z-shape or an N-shape between pixel regions. Referring to FIGS. 2 to 5, the numeral 1 represents an ITO slot which is formed by hollowing out an ITO on a common electrode corresponding to a pixel electrode in a pixel display region, and the ITO slots are arranged in at least two different directions. The numeral 2 represents a sub pixel electrode. For color displaying, on each layer of pixel display regions, patterns in three adjacent small diamonds respectively represent a red sub pixel electrode, a green sub pixel electrode and a blue sub pixel electrode; or for black-and-white displaying, patterns in the diamonds each are monochromatic sub pixel electrodes. If FIG. 2 corresponds to the color displaying, then in FIG. 2, R represents a red sub pixel electrode, G represents a green sub pixel electrode, and B represents a blue sub pixel electrode. In-plane electric fields in two or more directions can be obtained by designing ITO slots in two or more different directions, so that a multi-domain display effect of liquid crystal molecules can be achieved. As shown in FIGS. 2 and 3, a conventional rectangle pixel is changed into a diamond pixel, which can ensure an actual overturning area of liquid crystal molecule to obtain a higher light transmittance of the liquid crystal display. In the embodiment of the present disclosure, after the display is powered on, multi-domain displaying can be achieved with the liquid crystal molecules, thereby alleviating the color cast generated during displaying of the wide-viewing-angle liquid crystal display, further improving an aperture ratio, and improving a display effect of the wide-viewing-angle liquid crystal display effectively.

A wide-viewing-angle display method is further provided according to an embodiment of the present disclosure, which includes: forming alternately, in a hollowed-out mode, ITO slots in two or more directions on a common electrode corresponding to each pixel electrode, to obtain in-plane electric fields in two or more directions. Multi-domain displaying for liquid crystal molecules may further be achieved by changing a shape of the pixel. It can be understood that, for color displaying, each pixel electrode includes a red sub pixel electrode, a green sub pixel electrode and a blue sub pixel electrode; and for black-and-white displaying, each pixel electrode includes a monochromatic sub pixel electrode. In this case, the forming alternately, in a hollowed-out mode, ITO slots in at least two directions on a common electrode corresponding to each pixel electrode may include: forming alternately, in a hollowed-out mode, ITO slots in at least two directions on the common electrode corresponding to each sub pixel electrode.

In the embodiments of the present disclosure, ITO slots in at least two directions are formed alternately, in a hollowed-out mode, on a common electrode corresponding to a pixel electrode, which is different from a conventional comb-shaped uniform arrangement of common electrodes. In addition, the changed shape of the pixel ensures an actual overturning area of a liquid crystal molecule and ensures a high aperture ratio, providing compensation at different view angles to reduce fluctuations of light refractions of liquid crystal molecules at an oblique angle, thereby alleviating color cast.

It can be understood by those skilled in the art that, FIGS. 2 to 5 show merely the arrangements of ITO on the common electrode corresponding to the pixel electrode according to the embodiments in the present disclosure , but the arrangements of the ITO are not limited to the four types of arrangements. Other arrangements which can achieve the object of the embodiments of the present disclosure fall within the technical scope of the present disclosure, which is not limited herein.

In the above, the wide-viewing-angle liquid crystal display and the wide-viewing-angle display method according to the present disclosure are described in detail. Changes may be made to the particular embodiments and the applied range by those skilled in the art based on the concept of the embodiments of the present disclosure. In summary, the specification should not be understood to limit the present disclosure.

1. A wide-viewing-angle liquid crystal display, comprising a first substrate, liquid crystal molecules, common electrodes, pixel electrodes, a protection layer, a second substrate, Gate lines and Source lines; wherein ITO slots in two or more directions are formed alternately, in a hollowed-out mode, on a common electrode corresponding to each pixel electrode.

2. The wide-viewing-angle liquid crystal display according to claim 1, wherein for color displaying, each pixel electrode comprises a red sub pixel electrode, a green sub pixel electrode and a blue sub pixel electrode; or for black-and-white displaying, each pixel electrode comprises a monochromatic sub pixel electrode; and ITO slots in at least two directions are formed alternately, in a hollowed-out mode, on a common electrode corresponding to each sub pixel electrode.

3. The wide-viewing-angle liquid crystal display according to claim 1, wherein a shape of the pixel is diamond, and correspondingly the Gate lines and the Source lines are arranged in a Z-shape or an N-shape between pixel regions.

4. A wide-viewing-angle display method, comprising:
forming alternately, in a hollowed-out mode, ITO slots in two or more directions on a common electrode corresponding to each pixel electrode, to obtain in-plane electric fields in two or more directions.

5. The method according to claim 4, wherein each pixel electrode comprises a red sub pixel electrode, a green sub pixel electrode and a blue sub pixel electrode; or each pixel electrode comprises a black sub pixel electrode and a white sub pixel electrode; and the forming alternately, in a hollowed-out mode, ITO slots in two or more directions on a common electrode corresponding to each pixel electrode, to obtain in-plane electric fields in two or more directions comprises:
forming alternately, in a hollowed-out mode, ITO slots in two or more directions on a common electrode corresponding to each sub pixel electrode, to obtain in-plane electric fields in two or more directions.

6. The method according to claim 4, wherein a shape of the pixel is diamond.

7. The method according to claim 5, wherein a shape of the pixel is diamond.

8. The wide-viewing-angle liquid crystal display according to claim 2, wherein a shape of the pixel is diamond, and correspondingly the Gate lines and the Source lines are arranged in a Z-shape or an N-shape between pixel regions.
